(19) United States
(12) Patent Application Publication
(10) Pub. No.: US 2001/0034315 A1
(43) Pub. Date: Oct. 25, 2001

(54) Fabric softening compositions and compounds

(76) Inventors: David Stephen Grainger, Bebington (GB); Andrew Martin Creeth, Bebington (GB); James Patrick Conroy, Bebington (GB)

Correspondence Address: UNILEVER, PATENT DEPARTMENT, 45 RIVER ROAD, EDGEWATER, NJ, 07020, US

(21) Appl. No.: 09/741,377

(22) Filed: Dec. 20, 2000

(30) Foreign Application Priority Data
Dec. 22, 1999 (GB) 9930437.0

(51) Int. Cl. C11D 3/00; D06M 10/00

(52) U.S. Cl. 510/327; 510/329; 510/330; 510/515

(57) ABSTRACT

The invention provides a fabric softening composition comprising;

(i) at least one oily sugar derivative which is a liquid or soft solid derivative of a cyclic polyol or of a reduced saccharide, said derivative resulting from 35 to 100% of the hydroxyl groups it said polyol or in said saccharide being esterified or etherified, and wherein, the derivative has two or more ester or ether groups independently attached to alkyl or alkenyl chains derived from a fatty acid mixture comprising at least 50% by weight of a mixture of tallow fatty acid and oleyl fatty acid, and

(ii) one or more deposition aid(s).

The invention also provides a method of treating fabric by applying thereto the composition of the invention and the use of the aforementioned oily sugar derivatives within a fabric softening composition as a fabric softening aid that does not decrease the absorbency of the fabric. Also provided are the above mentioned oily sugar derivatives.

### TECHNICAL FIELD

The present invention relates to fabric softening compositions comprising particular oily sugar derivatives that provide good fabric softening performance and good re-wetability on fabric. The invention also relates to a method of treating clothes with these compositions.

### BACKGROUND AND PRIOR ART

Fabric softener compositions are well known in the art. However, a disadvantage associated with conventional fabric softeners is that although they increase the softness of a fabric they often simultaneously decrease its absorbency so that the ability of the fabric to take up water decreases. This is particularly disadvantageous with towels where the consumer requires the towel to be soft, and yet, have a high absorbency.

To overcome this problem it has been proposed to use fabric softening compositions comprising an oily sugar derivatives as a softening compound; it has been found that these compositions provide good softening without decreasing the absorbency (re-wetability) of the treated fabric.

WO 98/16538 (Unilever) discloses fabric softening compositions comprising liquid or soft solid derivatives of a cyclic polyol or a reduced saccharide which give good softening and retain absorbency of the fabric.

Our co-pending UK patent application GB 9911437.3 discloses fabric softening compositions comprising liquid or soft solid derivatives of a cyclic polyol or a reduced saccharide, at least one anionic surfactant, and at least one cationic polymer.

Our co-pending UK patent application GB 9911434.0 discloses fabric softening compositions comprising liquid or soft solid derivatives of a cyclic polyol or a reduced saccharide having at least one unsaturated bond in the alkyl or alkenyl chains present, and a deposition aid and one or more antioxidants.

EP 0 380 406 (Colgate-Palmolive) discloses detergent compositions comprising a saccharide or reduced saccharide ester containing at least one fatty acid chain.

WO 95/00614 (Kao Corporation) discloses softening compositions comprising polyhydric alcohol esters and cationised cellulose.

U.S. Pat. No. 5,447,643 (Hüls) discloses aqueous fabric softeners comprising mono, di or tri fatty acid esters of certain sugars(including esters of sucrose with degrees of esterification ranging from 1-4), nonionic surfactants and cationic protecting colloids.

WO 96/15213 (Henkel) discloses textile-softening agents containing alkyl, alkenyl and/or acyl group containing sugar derivatives, which are solid after esterification, in combination with nonionic and cationic emulsifiers including cationic fabric softening compounds.

To date the best performance for oily sugar derivative containing compositions has been achieved with a composition comprising a sucrose (poly) erucate (i.e. having C₂₂ chains with one unsaturated bond in the 13 position) and having an average degree of esterification between 4 and 5.

However because the fatty acid from which these chains are derived is not typically used in large-scale detergent manufacture, the erucate-based sugar ester is expensive and is not readily available at a competitive price on a large scale.

Accordingly there is a need to provide equivalent performance to the erucate-based sucrose ester but from a more readily available fatty acid feedstock.

The present invention is directed toward overcoming the above-mentioned disadvantages, and in particular, to providing a composition that provides good softening of a fabric without simultaneously markedly decreasing absorbency but based on readily available feedstocks.

It has been found that by mixing two different commonly available fatty acid feedstocks (tallow fatty acid and oleyl fatty acid) prior to the esterification or etherification of the starting material that softening performance equivalent to, or better than, erucate-based sugar esters is achieved. F Furthermore there is less of a tendency for the compositions to produce a malodour upon storage compared to using other oily sugar derivatives obtained from other polyunsaturated or predominantly unsaturated fatty acid feedstocks.

### DEFINITION OF THE INVENTION

According to one aspect of the invention there is provided a fabric softening composition comprising;

(i) at least one oily sugar derivative which is a liquid or soft solid derivative of a cyclic polyol or of a reduced saccharide, said derivative resulting from 35 to 100% of the hydroxyl groups in said polyol or in said saccharide being esterified or etherified, and wherein, the derivative has two or more ester or ether groups independently attached to alkyl or alkenyl chains derived from a fatty acid mixture comprising at least 50% by weight of a mixture of tallow fatty acid and oleyl fatty acid, and

(ii) one or more deposition aids.

According to a further aspect the present invention provides a method of treating fabric by applying thereto the above composition.

According to a further aspect the present invention provides the use of an oily sugar derivative as defined above within a fabric softening composition as a fabric softening aid that does not decrease the absorbency of the fabric.

According to a further aspect the present invention provides an oily sugar derivative as defined above.

### DETAILED DESCRIPTION OF THE INVENTION

The present invention provides a composition comprising an oily sugar derivative and a deposition aid to provide for the deposition of the derivative onto the fabric to be treated.

Oily Sugar Derivatives

The compositions comprise at least one oily sugar derivative which is a liquid or soft solid derivative of a cyclic polyol or of a reduced saccharide, said derivative resulting from 35 to 100% of the hydroxyl groups in said polyol or in said saccharide being esterified or etherified. The derivative has two or more ester or ether groups independently attached to alkyl or alkenyl chains derived from a fatty acid mixture comprising at least 50% by weight of a mixture of tallow fatty acid and oleyl fatty acid.

The oily sugar derivatives are also referred to herein as “derivative-CP” and “derivative-RS” dependent upon whether the derivative is the product derived from a cyclic polyol or from a reduced saccharide starting material respectively. Mixtures of the derivative-CP and derivative-RS may be used. Preferably the fatty acid mixture, used to provide the alkyl or alkenyl chains of the oily sugar derivatives of the cyclic polyol or reduced saccharide, comprises a mixture of tallow fatty acid and oleyl fatty acid in a weight ratio of 10:90 to 90:10, more preferably 25:75 to 75:25, most preferably 30:70 to 70:30. Particularly good results are obtained with a fatty acid mixture comprising a mixture of tallow fatty acid and oleyl fatty acid in a weight ratio of 60:40 to 40:60.

Especially preferred are mixtures comprising a weight ratio of approximately 50 wt % tallow chains and 50 wt % oleyl chains.

The fatty acid mixture used may further comprise other fatty acids having from C₈ to C₂₂ alkyl or alkenyl groups.

However, it is especially preferred that the fatty acid mixture comprises at least 50% by weight of the mixture of tallow fatty acid and oleyl fatty acid in the above weight ratios, preferably at least 60% by weight. More preferably the fatty acid mixture consists entirely of a mixture of tallow fatty acid and oleyl fatty acid in the above weight ratios.

The alkyl or alkenyl groups in the sugar oil may be branched or linear carbon chains.

The starting cyclic polyol or reduced saccharide material is esterified or etherified to the appropriate extent so that they are in the requisite liquid or soft solid state.

Preferably the derivative-CP and derivative-RS results from 35 to 85% most preferably 40 to 80%, even more preferably 45 to 75%, such as 45 to 70% of the hydroxyl groups in said cyclic polyol or in said reduced saccharide are esterified or etherified.

Preferably the derivative-CP or derivative-RS contains 35% by weight tri or higher esters, e.g. at least 40%.

The derivative-CP or derivative-RS used does not have any substantial crystalline character at 20° C. Instead it is in a liquid or soft solid state, as hereinbelow defined, at 20° C.

Preferably the derivative-CP or derivative-RS has 3 or more, preferably 4 or more, for example 3 to 8, e.g. 3 to 5, ester or ether groups or mixtures thereof.

For the derivative-CPs derivative-RSs the prefixes tetra, penta etc only indicate the average degrees of esterification or etherification. The compounds exist as a mixture of materials ranging from the monoester to the fully esterified ester. It is the average degree of esterification as determined by weight that is referred to herein.

Typically the derivative-CP and derivative-RS has 3 or more, preferably 4 or more, for example 3 to 8, e.g. 3 to 5, ester or ether groups or mixtures thereof. The alkyl or alkenyl groups may be branched or linear carbon chains.

Derivative-CPs are preferred for use in the compositions. Inositol is a preferred cyclic polyol, and Inositol derivatives are especially preferred.

In the context of the present invention the terms derivative-CP and derivative-RS encompass all ether or, ester derivatives of all forms of saccharides which fall into the above definition. Examples of preferred saccharides for the derivative-CP and derivative-RS to be derived from are monosaccharides and disaccharides.

Examples of monosaccharides include xylose, arabinose, galactose, fructose, sorbose and glucose. Glucose is especially preferred. An example of a reduced saccharide is sorbitan. Examples of disaccharides include maltose, lactose, cellobiose and sucrose. Sucrose is especially preferred.

If the derivative-CP is based on a disaccharide it is preferred if the disaccharide has 3 or more ester or ether groups attached to it. Examples include sucrose tri, tetra and penta esters.

Where the cyclic polyol is a reducing sugar it is advantageous if each ring of the CPE has one ether group, preferably at the C₁ position. Suitable examples of such compounds include methyl glucose derivatives.

Examples of suitable derivative-CPs include esters of alkyl(poly)glucosides, in particular alkyl glucoside esters having a degree of polymerisation from 1 to 2.

The HLB of the derivative-CP or derivative-RS is typically between 1 and 3.

Oleyl fatty acid is typically a fully unsaturated fatty acid. The level of unsaturation in the tallow fatty acid will vary according to the particular product used but it is generally in the range 40% to 70% unsaturated species in the fatty acid feedstock.

One or more of the other alkyl or alkenyl chains may be independently attached to the ester or ether groups and may contain at least one unsaturated bond. However it is most preferred that the alkyl or alkenyl chains are derived from only tallow and oleyl fatty acids.

If other alkyl or alkenyl chains are used with the tallow and oleyl based chains of the invention, it is preferred that any polyunsaturation in these other chains has been removed through partial hydrogenation.

The liquid or soft solid derivative-CP and derivative-RS are characterised as materials having a solid:liquid ratio of between 50:50 and 0:100 at 20° C. as determined by T₂ relaxation time NMR, preferably between 43:57 and 0:100, most preferably between 40:60 and 0:100, such as, 20:80 and 0:100. The T₂ NMR relaxation time is commonly used for characterising solid:liquid ratios in soft solid products such as fats and margarines. For the purpose of the present invention, any component of the NMR signal with a T₂ of less than 100 microsecond is considered to be a solid component and any component with T₂ greater than 100 microseconds is considered to be a liquid component.

The liquid or soft solid derivative-CP and derivative-RS can be prepared by a variety of methods well known to those skilled in the art. These methods include acylation of the cyclic polyol or reduced saccharide with an acid chloride; trans-esterification of the cyclic polyol or reduced saccharide with short chain fatty acid esters in the presence of a basic catalyst (e.g. KOH); acylation of the cyclic polyol or reduced saccharide with an acid anhydride and acylation of the cyclic polyol or reduced saccharide with a fatty acid. Typical preparations of these materials are disclosed in U.S. Pat. No. 4 386 213 and AU 14416/88 (Procter and Gamble).

The compositions preferably comprise between 0.5%-50 wt % of the oily sugar derivatives, more preferably 1-25 wt %, most preferably 3-20 wt %, based on the total weight of the composition.

The compositions may contain only the claimed oily sugar derivatives as the fabric softening compound or it may additionally contain one or more other nonionic fabric softening compound(s). Other nonionic fabric softening agents that may be used include pentaerythritol esters, and sorbitan esters, mono, di and triglycerides, non-sugar ester oils, mineral oils, fatty acids and fatty alcohols.

Deposition Aid

The compositions of the invention comprise one or more deposition aid(s).

In the context of the present invention a deposition aid is defined as any material that aids deposition of the oily sugar derivative onto a fabric during the laundering process.

The deposition aid may be selected from cationic surfactants, cationic fabric softening compounds, cationic polymers, nonionic surfactants, anionic surfactants, and mixtures thereof.

It is preferred if the deposition aid is cationic in nature. Cationic fabric softening compounds, cationic surfactants and cationic polymers have been found to be particularly advantageous.

If a cationic fabric softening compound or cationic surfactant is not present in the formulation it is preferred if a cationic polymeric deposition aid is present.

Most preferably the deposition aid is a cationic fabric softening compound.

Mixtures of deposition aids may be used, for example, a mixture of a cationic surfactant and a nonionic surfactant, or a fabric softening compound and a polymeric deposition aid.

(i) Cationic Fabric Softening Compound

The compositions preferably comprise one or more one cationic fabric softening compounds as the deposition aid, preferably such compounds having two or more alkyl or alkenyl chains each having an average chain length equal to, or greater, than C₈.

Quaternary ammonium fabric softening compounds may be used as the cationic fabric softening compound. It is advantageous for environmental reasons if the quaternary ammonium material is biologically degradable.

Preferably the cationic fabric softening compound is a quaternary ammonium compound having two or more, e.g. three, C₁₂₋₂₈ alkyl or alkenyl chains, most preferably connected to a nitrogen atom via at least one ester link. Quaternary ammonium compounds having two or three C₁₂₋₂₈ alkyl or alkenyl chains, preferably connected to a nitrogen atom via at least one ester link, are especially preferred.

Especially suitable compounds have two or more alkyl or alkenyl chains each having an average chain length equal to or greater than C₁₄ more preferably equal to or greater C₁₆. Most preferably at least 50% of the total number of said chains have a chain length equal to or greater than C₁₈.

It is preferred if the alkyl or alkenyl chains of the cationic fabric softening compound are predominantly linear.

In particular, quaternary ammonium fabric softening compounds comprising a polar head group and two or three alkyl or alkenyl chains each having an average chain length equal to or greater than C₁₄ may be used.

A first preferred type of ester-linked quaternary ammonium material for use as the cationic fabric softening compound is represented by the formula (I):

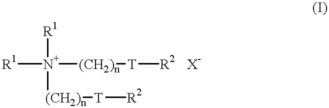

wherein each R¹ group is independently selected from C₁₋₄, alkyl or hydroxyalkyl or C₂₋₄ alkenyl groups; and wherein each R group is independently selected from

C₈₋₂₈ alkyl or alkenyl groups;

T is

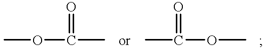

X⁻ is any suitable anion including a halide, acetate or lower alkosulphate ion, such as chloride or methosulphate, and n is 0 or an integer from 1-5.

Di(tallowoyloxyethyl) dimethyl ammonium chloride and methyl bis-[ethyl (tallowoyl)]-2-hydroxyethyl ammonium methyl sulphate are especially preferred. The tallow chains in these compounds may be hardened and may even be fully unsaturated, i.e. preferred compounds also include di(hardened tallowoyloxy ethyl) dimethyl ammonium chloride and methyl bis-[ethyl(hardened tallowoyl)]-2-hydroxyethyl ammonium methyl sulphate. Commercially available compounds include those in the Tetranyl range (ex Kao) and Stepantex range (ex Stepan).

A second preferred type of ester-linked quaternary ammonium material for use as the cationic fabric softening compound is represented by formula (II):

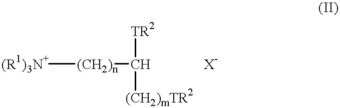

wherein R¹, R², n, T and X are as defined above, and m is from 1 to 5.

Preferred materials of this class such as 1,2 bis[hardened tallowoyloxy]-3-trimethylammonium propane chloride and their method of preparation are, for example, described in U.S. Pat. No. 4,137,180 (Lever Brothers). Preferably these materials comprise small amounts of the corresponding monoester as described in U.S. Pat. No. 4,137,180 for example 1-hardened tallowoyloxy-2-hydroxy 3-trimethylammonium propane chloride.

A third preferred type of ester-linked quaternary ammonium material for use as the cationic fabric softening compound is represented by formula (III):

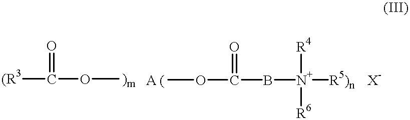

wherein X⁻ is as defined above, A is an (m+n) valent radical remaining after the removal of (m+n) hydroxy groups from an aliphatic polyol having p hydroxy groups and an atomic ratio of carbon to oxygen in the range of 1.0 to 3.0 and up to 2 groups per hydroxy group selected from ethylene oxide and propylene oxide, m is 0 or an integer from 1 to p-n, n is an integer from 1 to p-m, and p is an integer of at least 2, B is an alkylene or alkylidene group containing 1 to 4 carbon atoms, R³, R⁴, R⁵ and R⁶ are, independently from each other, straight or branched chain C₁-C₄₈ alkyl or alkenyl groups, optionally with substitution by one or more functional groups and/or interruption by at most 10 ethylene oxide and/or propylene oxide groups, or by at most two functional groups selected from

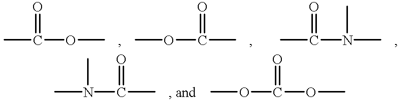

or R⁴ and R⁵ may form a ring system containing 5 or 6 atoms in the ring, with the proviso that the average compound either has at least one R group having 22-48 carbon atoms, or at least two R groups having 16-20 carbon atoms, or at least three R groups having 10-14 carbon atoms. Preferred compounds of this type are described in EP 638 639 (Akzo).

A preferred class of quaternary ammonium cationic fabric softening agents that do not contain an ester linking group is defined by formula (IV):

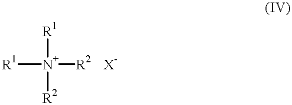

wherein each R¹ group is independently selected from C₁₋₄ alkyl, hydroxyalkyl or C₂₋₄ alkenyl groups; R² group is independently selected from C₈₋₂₈ alkyl or alkenyl groups, and X⁻ is as defined above.

A preferred material of formula (IV) is di-hardened tallow-dimethyl ammonium chloride, sold under the Trademark ARQUAD 2HT by Akzo Nobel.

The compositions preferably comprise between 0.5% wt-30% wt of the cationic fabric softening compound, preferably 1%-25%, more preferably 1.5-20%, most preferably 2%-15%, based on the total weight of the composition.

Where a cationic fabric softening compound is used as the deposition aid, the weight ratio of said compound:oily sugar derivatives is preferably in the range 99:1 to 1:10, preferably 10:1 to 1:5, more preferably 5:1 to 1:1, most preferably 3:1 to 1:1. The cationic fabric softening compound is preferably present in the composition in an amount of 50%-99% by weight, preferably 55%-85% based on the total weight of the cationic fabric softening compound and oily sugar derivatives.

If the oily sugar derivative or quaternary ammonium softening compound comprises hydrocarbyl chains formed from fatty acids or fatty acyl compounds which are unsaturated or at least partially unsaturated (e.g. having an iodine value of from 5 to 140, preferably 5 to 100, more preferably 5 to 60, most preferably 5 to 40, e.g. 5 to 25), then the cis:trans isomer weight ratio in the fatty acid/fatty acyl compound is greater than 20/80, preferably greater than 30/70, more preferably greater than 40/60, most preferably greater than 50/50, e.g. 70/30 or greater. It is believed that higher cis:trans isomer weight ratios afford the compositions comprising the compound better low temperature stability and minimal odour formation. Suitable fatty acids include Radiacid 406, ex Fina.

Saturated and unsaturated fatty acids/acyl compounds may be mixed together in varying amounts to provide a compound having the desired iodine value.

Fatty acids/acyl compounds may also be, at least partially hydrogenated to achieve lower iodine values.

Of course, the cis:trans isomer weight ratios can be controlled during hydrogenation by methods known in the art such as by optimal mixing, using specific catalysts and providing high H₂ availability.

(ii) Cationic Surfactant

The compositions may comprise one or more one cationic surfactants, (which are not cationic fabric softening compounds) as the deposition aid.

Suitable cationic surfactants include those having a single C₈-C₂₈ alkyl or alkenyl chain, preferably a single C₈-C₂₀ alkyl or alkenyl chain, most preferably a single C₁₀-C₁₈ alkyl or alkenyl chain.

Examples include water soluble single chain quaternary ammonium compounds such as cetyl trimethyl ammonium chloride, cetyl trimethyl ammonium bromide, or any of those listed in European Patent No. 258 923 (Akzo). For example the cationic surfactant may be an alkyl tri-methylammonium methosulphate or chloride or alkyl ethoxylalkyl ammonium methosulphate or chloride. Examples include coconut pentaethoxymethyl ammonium methosulphate and derivatives in which at least two of the methyl groups on the nitrogen atom are replaced by (poly)alkoxylated groups.

Preferably, the cation in the cationic surfactant is selected from alkyl tri-methylammonium methosulphates and their derivatives, in which, at least two of the methyl groups on the nitrogen atom are replaced by (poly)alkoxylated groups.

Any suitable counter-ion may be used in the cationic surfactant. Preferred counter-ions include halogens (especially chlorides), methosulphate, ethosulphate, tosylate, phosphate and nitrate.

Suitable commercially available cationic surfactants include the Ethoquad range from Akzo, e.g. Ethoquad 0/12 and Ethoquad HT/25.

The cationic surfactant is preferably present in an amount of 0.01% to 5% by weight, preferably 0.05%-3%, more preferably 0.1%-2% based on the total weight of the composition.

(iii) Cationic Polymers

The compositions may comprise one or more one cationic polymers as the deposition aid. If the cationic polymer is used as the deposition aid then preferably at least one anionic surfactant, nonionic surfactant and/or zwitterionic surfactant is present.

Suitable cationic polymers include cationic-guar polymers such as; the JAGUAR® series of polymers (ex Rhodia), cationic cellulose derivatives such as CELQUATS®, (ex National Starch), UCARE® polymers (ex Amerchol), cationic starches e.g. potato starch such as SOFTGELS®, eg BDA and BD (both ex Avebe), and the C* bond polymers from Cerestar, AMYLOFAX® and SOLVITOSE® polymers (both ex Avebe), POLYGEL polymers K 100 and K200 (ex Sigma), cationic polyacrylamides such as PCG (ex Allied Colloids) and FLOCAID® series of polymers (ex National Starch) and cationic chitosan derivatives.

Deflocculating polymers as described in EP 415 698 and EP 458 599 may also be included.

These polymers may be present in the compositions in an amount of 0.01 to 5% by weight based upon the total weight of the composition, more preferably 0.02-2.5%, such as 0.05-2%.

Optional Ingredients

Especially preferred optional ingredients are antioxidants. The compositions preferably comprise one or more antioxidants to reduce malodour that may form upon storage, e.g. in an amount of 0.0001% to 1% by weight (in total). Preferably the antioxidant comprises at least one initiation inhibitor antioxidant and/or at least one propagation inhibitor as described in our co-pending application number GB 9911434.0. Mixtures of these two types of antioxidants have been found to be particularly beneficial, especially in reducing medium to long term malodour.

The compositions may further comprise one or more nonionic surfactant(s).

Suitable nonionic surfactants include the condensation products of C₈-C₃₀ primary or secondary linear or branched alcohols preferably C₁₀-C₂₂ alcohols, alkoxylated with 10 or more moles of alkylene oxide, preferably 10-25 moles of alkylene oxide, more preferably between 11 and 20 moles of alkylene oxide. Preferably the alkylene oxide is ethylene oxide although it may be/include propoxylate groups. The alcohols may be saturated or unsaturated.

Suitable alcohol ethoxylates include the condensation products of coconut fatty alcohol with 15-20 moles of ethylene oxide, e.g. coco 20 ethoxylate, and, condensation products of tallow alcohol with 10-20 moles of ethylene oxide, e.g. tallow 15 ethoxylate. Other suitable examples include alkyl poly glucosides and other sugar based surfactants e.g. ethoxylated sorbitans.

The nonionic surfactants preferably have an HLB of from about 10 to a bout 20, for example from 11 to 16.

The nonionic surfactants are typically present in an amount of from 0.1 wt % to 10 wt %, preferably 0.2 wt % to 5 wt %, based on the total weight of the composition.

The compositions may also contain fatty acids, for example C₈-C₂₄ alkyl or alkenyl monocarboxylic acids, or, polymeric carboxylic acids. Preferably saturated fatty acids are used, in particular, hardened tallow C₁₆-C₁₈ fatty acids.

It may be advantageous if a viscosity control agent is present in the liquid compositions. These agents may help to improve the stability of the compositions, for example by slowing down, or stopping, any tendency of the composition to separate and help to achieve a desirable viscosity for the final composition as required by the consumer.

Amphoteric and zwitterionic surfactants may also be used. Preferred types include amine oxides, betaines including sulphobetaines and tegobetaines, phosphine oxides and sulphoxides e.g. coco amido propyl betaine.

Suitable amine oxides include those containing one alkyl moiety of from about 10 to about 18 carbon atoms and 2 moieties selected from the group consisting of alkyl groups and hydroxyalkyl groups containing from about 1 to about 3 carbon atoms e.g alkyl dimethyl amine oxide; water-soluble phosphine oxides containing one alkyl moiety of from about 10 to about 18 carbon atoms and 2 moieties selected from the groups consisting of alkyl groups and hydroxyalkyl groups containing from about 1 to about 3 carbon atoms; and water-soluble sulfoxides containing one alkyl moiety of from about 10 to about 18 carbon atoms and a moiety selected from the groups consisting of alkyl and hydroxyalkyl moieties of from about 1 to about 3 carbon atoms.

Conventional types and amounts of anionic surfactants may be included if they are compatible with the deposition aid.

Any viscosity control agent conventionally used with rinse conditioners is suitable for use with the present invention, for example decoupling polymers and deflocculating polymers. Synthetic polymers such as polyacrylic acid, poly vinyl pyrrolidone, polyethylene, carbomers, cross linked polyacrylamides such as ACOSOL® 880/882 polyethylene and polyethylene glycols polymers are useful viscosity control agents.

Nonionic polymers may also be included in the compositions. Suitable nonionic polymers include PLURONICS® (ex BASF), dialkyl PEGs, cellulose derivatives as described in GB 213 730 (Unilever), hydroxy ethyl cellulose, starch, and hydrohobically modified nonionic polyols such as ACUSOL® 880/882 (ex Rohm & Haas).

Mixtures of any of the aforementioned cationic and/or nonionic polymers may be used. These polymers may be present in the compositions in an amount of 0.01 to 5% by weight based upon the total weight of the composition, more preferably 0.02-2.5%, such as 0.05-2%.

The composition may also contain one or more optional ingredients, selected from dyes, preservatives, electrolytes, non-aqueous solvents, pH buffering agents, perfumes, perfume carriers, fluorescers, hydrotropes, antifoaming agents, antiredeposition agents, polymeric and other thickeners, enzymes, optical brightening agents, opacifiers, anti-shrinking agents, anti-wrinkle agents, anti-spotting agents, germicides, fungicides, anti-corrosion agents, drape imparting agents, antistatic agents, sunscreens, colour care agents and ironing aids.

Typically the compositions will comprise one or more perfumes conventionally used in fabric softening compositions.

Water

The compositions preferably contain water in an amount of at least 50% by weight, more preferably at least 60%, for example at least 70%, based on the total weight of the composition.

Product Form

The compositions of the invention may be in any physical form including gels, liquids, powders and granules. Liquids, especially emulsions, are preferred. Emulsion compositions are particularly preferred.

Preparation of the Compositions

The compositions may be prepared by any suitable manner.

It is especially preferred that when the deposition aid is a cationic fabric softening agent the compositions are produced by a method wherein the softening compound and the oily sugar derivative are not co-melted together. It is preferred that either the derivative or the cationic softening compound is pre-mixed with a cationic surfactant, a nonionic surfactant or a perfume (of the types described herein) before the derivative and the softening compound are brought into contact. Preferably both the derivative and the softening compound are both pre-mixed in this manner.

It is especially preferred that if optional minor ingredients which are polyelectrolytes are present, such as preservative, these are added after the oily sugar derivatives and the deposition aid have been brought into contact. If these components are added before this occurs then the compositions may not be stable and/or complexation of the oily sugar derivatives and the deposition aid may occur.

Method of Treating Fabrics

The invention also provides a method of treating fabrics by applying thereto the compositions of the invention. The compositions can by applied to the fabric by any suitable method. The preferred methods are by treatment of the fabric during a domestic laundering process such as by soaking, or, in the rinse cycle of a domestic washing machine.

### EXAMPLES

The invention is further illustrated by the following non-limiting examples. Further modifications within the scope of the present invention will be apparent to the person skilled in the art.

All percentages in the following examples are by weight based upon the total weight of the composition. The examples according to the invention are denoted by numbers. The comparative examples are denoted by letters.

A. Synthesis of Sucrose (Poly)Esters Having Mixed Tallowate and Oleylate Chains.

Four sucrose ester oils having an average degree of esterification of about 4 and mixed tallow and oleyl alkyl or alkenyl chains attached to the ester groups were synthesised from sucrose and a mixture of tallow fatty acid and oleyl fatty acid comprising the fatty acids in the weight ratios given below. RT as used below refers to room temperature.

Synthesis Of 40:60 Tallow:Oleyl Fatty Acid Chloride Feedstock.

A stirred solution of 40:60 (weight percent) Oleic (oleyl) fatty acid:Tallow fatty acid (100 g total; 0.36 mole) in dichloromethane at 40° C. was prepared. To this 2M oxalyl chloride solution in dichloromethane (200 ml; 0.4 mole) was added dropwise over 45 minutes. Upon completion of addition the reaction mix was left to stir for a further 60 minutes before removal of the dichloromethane and excess oxalyl chloride at reduced pressure. Infra-red spectrometry confirmed the presence of the acid chloride with a characteristic peak at 1798 cm⁻¹.

### Synthesis of Example 1

40:60 Tallow:Oleyl Sucrose Partial Esters.

Sucrose (15 g; 0.0438 mole) was dissolved in dry pyridine 30 (300 cm ) by warming to 120° C. and then cooling to RT whereon a catalytic amount of DMAP was added. A solution of the mixed 40:60 w/w Oleyl:Tallow acid chlorides (57 g; 0.193 mole), was prepared in dry chloroform (100 cm³) and added dropwise over 45 minutes to the -sucrose/pyridine mixture. A slight exotherm was produced and the temperature rose to about 35° C. The reaction was stirred for a further 4 hours at RT. After standing overnight the pyridine and chloroform were removed under reduced pressure. The resulting material was redissolved in chloroform (400 cm³), and washed with dilute HCl. The mixture was allowed to separate, the chlorinated layer run off and washed with water and then with saturated brine solution until neutral before drying with anhydrous magnesium sulphate overnight. The sulphate was filtered off before removing the chloroform under reduced pressure to yield a brown oily residue.

Analysis by H NMR in CDCl₃/TCAI indicated ˜3.8 ester groups per sucrose moiety and HPLC showed a range of esters.

### Synthesis of Example 2

50:50 Tallow:Oleyl Sucrose Partial Esters.

The same method as for Example 1 was followed as above but the ratio of the fatty acids in the starting material was 50:50 wt % tallow:oleyl. 58 g of the mixed fatty acid chloride was used in the reaction with sucrose (15 g). The reaction yielded a brown oily residue with an average of 3.9 ester groups per sucrose moiety.

### Synthesis of Example 3

60:40 Tallow:Oleyl Sucrose Partial Esters.

The method of Example 2 synthesis applies but the ratio of fatty acids used was 60:40 wt % tallow:oleyl. The reaction yielded a brown oily residue with an average of 4.0 ester groups per sucrose moiety.

### Synthesis of Example 4

70:30 Tallow:Oleyl Sucrose Partial Esters.

The method of Example 2 synthesis applies but the ratio of fatty acids used was 70:30 wt % tallow:oleyl. The reaction yielded a brown oily residue with an average of 4.5 ester groups per sucrose moiety.

TABLE 1
sucrose ester oils (with mixed tallow/oleyl chains)
synthesised

| | Tallow:oleyl fatty | Average degree |
|---|---|---|
| | acid mixture | of |
| Example | weight ratio used. | esterification |
| Example 1 | 40:60 | 3.8 |
| Example 2 | 50:50 | 3.9 |
| Example 3 | 60:40 | 4.0 |
| Example 4 | 70:30 | 4.5 |
| Comparative | — | 4.5-5* |
| Example A | | |
| Sucrose Erucate | | |

B. Evaluation of Softening and Absorbency Performance

The softening performance of examples 1 to 4 was evaluated by adding 0.1 g of the compound (2 ml of a 5 wt:dispersion) to 1 liter of tap water, at ambient temperature in a tergotometer. One ml of a 1 wt % alkyl benzene sulphonate was added to simulate anionic surfactant carried over form the main wash.

Three pieces of terry towelling (8 cm×8 cm, 40 g total weight) were added to the tergotometer pot. The cloths were treated for 5 minutes at 65 rpm, spin dried to remove excess liquor and line dried overnight and conditioned at 21° C./65% humidity for 24 hours.

Softening of the fabrics was assessed by an expert panel of 4 people using a round robin paired comparison test protocol. Each panel member assessed four sets of test cloths. Each set of test cloths contained one cloth of each test system under evaluation. Panel members were asked to assess softness on an 8-point scale. Softness scores were calculated using an “Analysis of Variance” technique. Lower values indicate better softening as assessed by the panellists.

TABLE 2
Softening scores from the above examples

| Example | Softness score |
|---|---|
| 1 | 4.00 |
| 2 | 3.94 |
| 3 | 4.19 |
| 4 | 4.31 |
| Comparative Example A | 4.125 |
| Comparative Example B | 4.25 |

Comparative example B is sucrose tetra oleate (i.e. having 100% oleyl chains). It was prepared as by the method given for example 2 but in this case oleic acid only was used in the starting material. The reaction yielded a brown oily residue with an average of 4.0 ester groups per sucrose moiety.

The above results demonstrate that the sugar ester oils produced from specific Tallow:oleyl fatty acid mixtures provide at least equivalents softening performance to the previously most effective, sugar ester oils. Thus the claimed compositions provide a realistic alternative to compositions comprising the above mentioned sucrose euracte.

### Example 5

The composition below was prepared by co-melting the cationic softener and the coconut 20 ethoxylate together and adding this co-melt to water which was at 75° C. This mixture was cooled to 50° C. and then a mixture of the oily sugar derivative and the perfume was added thereto with stirring. Finally the ‘minors’ were added and the mixture cooled with stirring to room temperature.

All percentages are by weight based on the amount of raw material added, except for Example 1 which was added as the compound.

| | % by weight |
|---|---|
| Cationic softener (1) | 7.64% |
| Example 1 oily sugar | 2.0% |
| derivative | |
| Coconut 20 EO nonionic | 0.3% |
| surfactant (2) | |
| Perfume | 0.54% |
| Minors and water | To 100% |

(1) 1,2 bis [hardened tallowoyloxyl]-3-trimethyl ammonium propane chloride available from Clariant (78.5% active composition).
(2) Genapol 0200 available from Clariant.

1. A fabric softening composition comprising;
(i) at least one oily sugar derivative which is a liquid or soft solid derivative of a cyclic polyol or of a reduced saccharide, said derivative resulting from 35 to 100% of the hydroxyl groups in said polyol or in said saccharide being esterified or etherified, and wherein, the derivative has two or more ester or ether groups independently attached to alkyl or alkenyl chains derived from a fatty acid mixture comprising at least 50% by weight of a mixture of tallow fatty acid and oleyl fatty acid, and
(ii) one or more deposition aids

2. A composition according to claim 1 wherein the fatty acid mixture comprises a mixture of tallow fatty acid and oleyl fatty acid in a weight ratio of tallow fatty acid:oleyl fatty acid of 10:90 to 90:10, preferably 25:75 to 75:25.

3. A composition according to claim 2 wherein the fatty acid mixture consists entirely of a mixture of tallow fatty acid and oleyl fatty acid.

4. A composition according to claim 1, wherein the oily sugar derivative results from 40-80%, preferably 45-75% of the hydroxyl groups in said cyclic polyol or in said reduced saccharide being esterified or etherified.

5. A composition according to claim 1, wherein the composition comprises between 0.5%-50% wt of the oily sugar derivative, more preferably 3-20% wt, based on the total weight of the composition.

6. A composition according to claim 1, wherein the one or more deposition aid(s) is selected from cationic fabric softening compounds, cationic surfactants and/or cationic polymers.

7. A composition according to claim 6, wherein the cationic fabric softening compound is a quaternary ammonium compound having two or three C₁₂₋₂₈ alkyl or alkenyl chains, preferably connected to a nitrogen atom via at least one ester link.

8. A composition according to claim 6 wherein the weight ratio of the cationic fabric softening compound:oily sugar derivative is in the range 99:1 to 1:10, preferably 10:1 to 1:5.

9. A method of treating fabric by applying thereto the composition of claim 1.

10. Use of an oily sugar derivative as defined in claim 1 within a fabric softening composition as a fabric softening aid that does not decrease the absorbency of the fabric.

11. An oily sugar derivative as defined in claim 1.
